(19) United States
(12) Patent Application Publication
(10) Pub. No.: US 2002/0073166 A1
(43) Pub. Date: Jun. 13, 2002

(54) Method, system, and apparatus for providing message data regarding events associated with websites

(76) Inventor: Michael P. Lynch, Atlanta, GA (US)

Correspondence Address: Jennifer Pearson Medlin, Esq., NEEDLE & ROSENBERG, P.C., The Candler Building, Suite 1200, 127 Peachtree Street, N.E., Atlanta, GA, 30303-1811, US

(21) Appl. No.: 09/732,507

(22) Filed: Dec. 7, 2000

Related U.S. Application Data
(60) Provisional application No. 60/170,029, filed on Dec. 10, 1999.

(51) Int. Cl. G06F 15/16

(52) U.S. Cl. 709/217; 709/218

(57) ABSTRACT

A method, system, and apparatus that provide message data. A link to a message application is included in at least one web page for each event associated with the website for which message data is desired. A user accesses the web page, selects the link to the message application associated with the at least one event, and inputs user information, e.g., in response to a prompt to the user to input information. The user inputs user registration information if such information has not already been input by the user. The user information may be shared among websites and may be used to create a user event profile that is portable among websites. Message data is automatically sent to the user regarding the event, based on the input user information. The message data may be sent at a time determined according to the input user information. The message data may include information regarding the timing of the event. A link to the same message application may be included in each web page for each event for which message data is desired.

This application claims the benefit of U.S. Provisional Application No. 60/170,029, which was filed on Dec. 10, 1999, the entirety of which is incorporated herein by reference.

### BACKGROUND OF THE INVENTION

The present invention is directed to a method, system, and apparatus for providing personalized message data. More particularly, the present invention is directed to a method, system and apparatus for providing personalized message data to users regarding events associated with websites using links in the websites to the same message application.

The Internet has grown significantly over the past few years. Several types of Internet connections are currently available. For example, a user may connect the Internet by dialing into it via a computer at an Internet Service Provider's (ISP's) facility using a modem and a standard telephone line, or the user may connect to the Internet via an Internet-enabled wireless device, such as a wireless telephone. Through this Internet connection, the user can access information on the web using a computer program referred to as a web browser. The web browser is a software program that runs, e.g., on a standard personal computer with a modem or on a wireless Internet-enabled device, and allows a user to view the data received from a website.

To access information on the Internet, the user provides the web browser with a Uniform Resource Locator (URL) for a resource accessible on the Internet. The URL contains the name of the protocol required to access the resource, a domain name that identifies a specific computer on the Internet, and a hierarchical description of a file location on the computer. The type of resource depends on the Internet application protocol. For example, using the Hypertext Transfer Protocol (HTTP) or Wireless Application Protocol (WAP), the resource may be a web page, an image file, a program such as a common gateway interface (CGI) application, or any other file supported by the web browser. Web pages often include hyperlinks, i.e., words or phrases representing other pages in a form that gives the web browser the URL for the corresponding web page.

When the user selects a website to visit, the URL provided by the user to the web browser identifies a specific host computer on the Internet, referred to as a web server. The web server may support personal computer based Internet communication and/or wireless device based Internet communication. The URL identifies the location of a resource such as a web page located at the particular web server. The server receives a request from the browser for a specific URL and attempts to fulfill the request. The fulfilled request is then returned to the browser. If the request is for a web page, the page is displayed for the user.

Websites are often associated with events of which users may wish to be informed or which are related to a user's particular interests or events in his or her life. Typically, users are required to visit the websites and enter information each time they want to receive information related to an event. If the user desires to receive information regarding events from several different websites, this could turn out to be quite cumbersome.

Techniques have been proposed for automatically providing users with information about events associated with websites without requiring that the users visit the websites. However, such techniques require that each website owner creates an application to provide users with information about the events. The users must then register with each of these applications at each website. Website owners may not be familiar with these types of applications, and developing and implementing an application to provide users with information about events may turn out to be quite cumbersome and expensive for the website owner. Also, the users must remember login information for each website, thus making this approach cumbersome for the users.

Thus, there is a need for a more simplified technique for informing users of events associated with websites that reduces the burden on the users and the website owner.

### SUMMARY OF THE INVENTION

The present invention is directed to a method, system, and apparatus for providing information to users of websites regarding events associated with the websites in a simple manner that places minimal burdens on the users and the website owners.

A method, system, and apparatus provide personalized message data for events associated with at least one website automatically to users. A link to an event message application is included in at least one web page at the website for each event associated with the website for which message data is desired. A user accesses the web page, selects the link to the event message application associated with the at least one event, and inputs user information, e.g., in response to a prompt to the user to input information. The user inputs user registration information if such information has not already been input by the user. The user information may be shared among websites and may be used to create a user event profile that is portable among websites. Message data is automatically sent to the user regarding the event, based on the input user information. The event message data may be sent at a time determined according to the user input information. The message data may be stored until such time is reached. The message data may include information regarding the timing of the event, e.g., a date certain or data relative to a date and/or time input by the user, or any other information regarding the event or the user's preferences or other personal information. A link to the same event message application may be included in each web page for each event for which message data is desired.

According to exemplary embodiments, once a user has registered with the message system via a particular website, he or she is not required to register again, even if the user wants to access the message system via another website. The user only needs to remember the login information for a single message system, and this login information can be used to log into the system from any website through which the messaging system can be accessed. This reduces the burden on the user. Also, a benefit to the website owner is that user information can be shared among the websites, and a minimal amount of input information is required from the user to access the message system. This enriches the amount of information available to any website but reduces the burden of collecting information for each individual website owner.

The objects, advantages and features of the present invention will become more apparent when reference is made to the following description taken in conjunction with the accompanying drawings.

### BRIEF DESCRIPTION OF THE DRAWINGS

FIG. 1A is a block diagram illustrating a system for providing event message data according to an exemplary embodiment;

FIG. 1B illustrates an exemplary message system in detail;

FIG. 2 illustrates an example of event profile portability and data sharing between web pages; and

FIG. 3 illustrates a method for providing event message data according to an exemplary embodiment.

### DETAILED DESCRIPTION OF THE INVENTION

According to an exemplary embodiment, message data regarding events associated with websites is provided automatically to users, without requiring that the user register with the message system at each website. When the user registers at a website or inputs any information at any website, this information may be shared among other websites. User input information is also used to create a user event profile that is portable among different websites. Message data is sent to a user based on the user event profile.

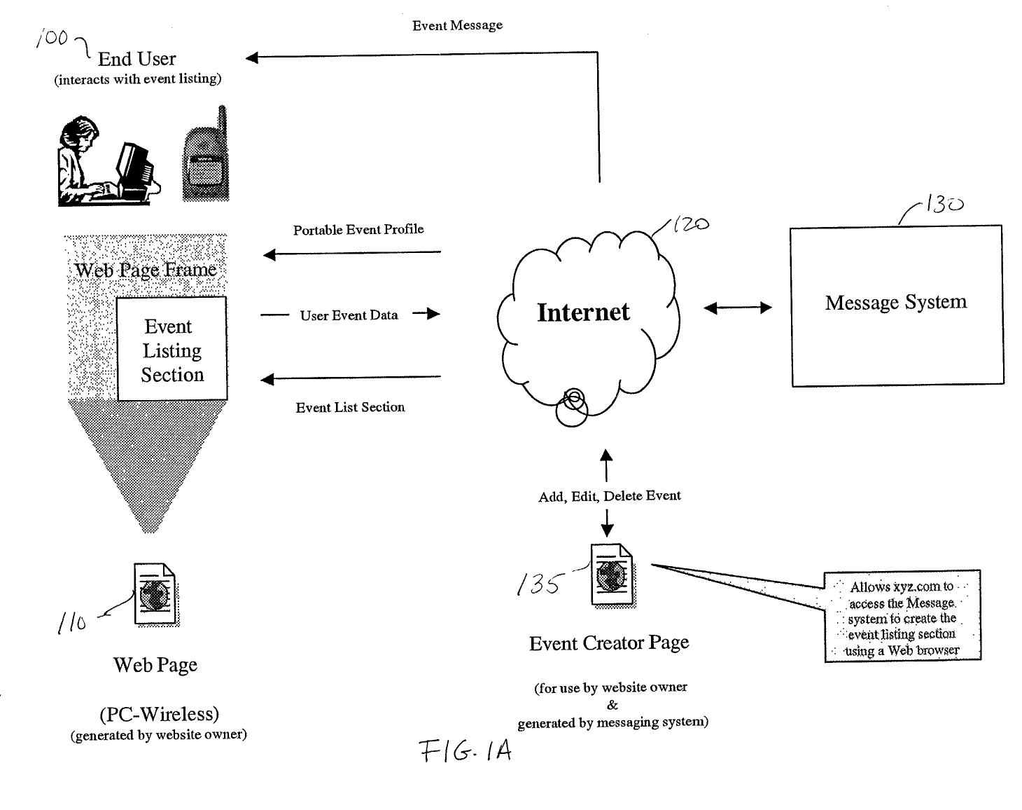

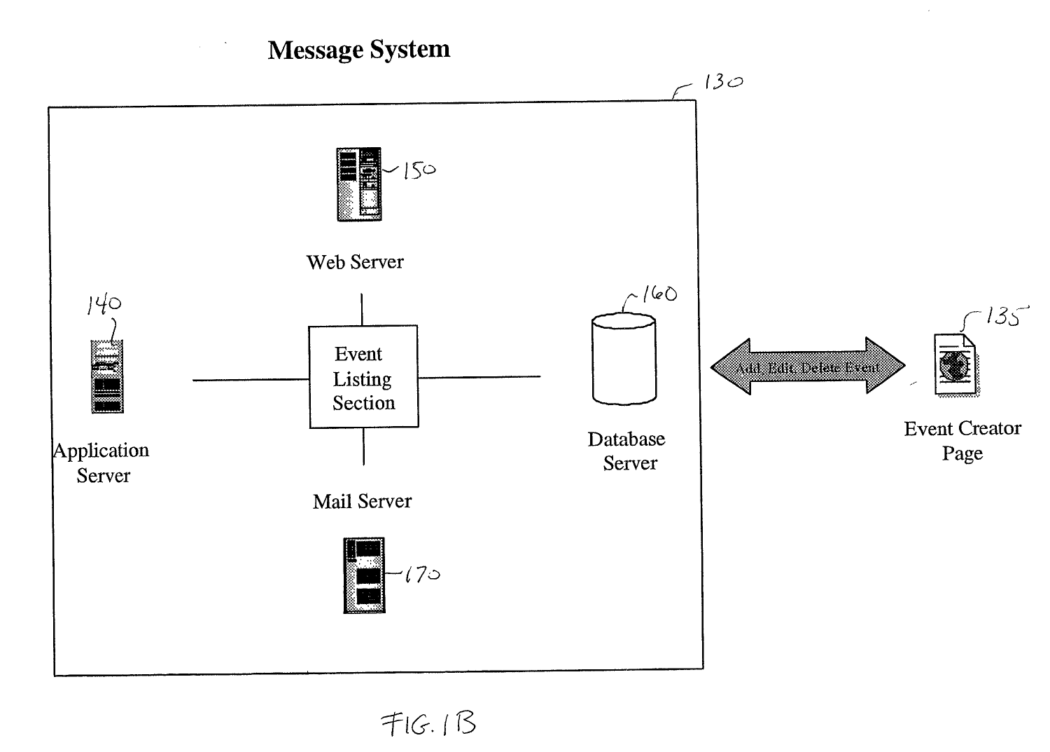

FIG. 1A illustrates a system for providing message data to users regarding events associated with websites according to an exemplary embodiment. As shown in FIG. 1, a user 100, e.g., a user communicating through a personal computer or a wireless device, communicates with at least one host web page 110 provided by a website owner via the Internet 120. The host web page 110 may be configured for display and interaction via a personal computer and/or a wireless device. In the interest of simplicity, only one user 100 and one host web page 110 are shown in FIG. 1A. However, it will be appreciated that the invention is applicable to any number of users and web pages.

An event message system 130 is also connected to the Internet 120. The message system provides message data to the user via the host web page 110. For this purpose, each website owner includes in its web page(s) a link to a message application provided by the message system for providing message data to users regarding events associated with the website. For example, code may be included in the host page 110 that calls the event message application in the message system. The message application may be called indirectly by the host web page 110, the servers in the message system executing the code, or the host web page may directly execute code on the message system servers.

FIG. 1B illustrates the message system 130 in detail. The message system 130 includes an application server 140, a web server 150, a database server 160, and a mail server 170, all of which cooperate to produce an event listing web page, which is included as an event listing section framed by the host web page 110. The event listing web page is generated by the web server 150 and serves as the mechanism to communicate the event information provided by the user to the database server 160, the application server 140, and the mail server 170. Its location is referred to by the host web page 110 to present the user 100 with event information. The application server 140 is a collection of programs that performs processing and coordinating between the database server 160, the web server 150 and the mail server 170. The application server 140 contains information regarding the messages and presents this information to users, upon request. The database server 160 stores information entered by the user, including information regarding when the messages data should be sent to the users. The mail server 170, which may be an email server, sends the message data to the user at the appropriate time.

According to an exemplary embodiment, a website owner using a host page 110 obtains event messaging service from the message system 130, by accessing the website provided by the message system 130, e.g., via the web server 150, and executing an application provided by the website for creating an event. This application may be referred to as the Event Creator (EC) application. The EC application prompts the website owner via the event creator page 135 for certain information, e.g., the name of the event, the timing of the event, the category of the event, etc. After the website owner enters this information, the EC application verifies the event, e.g., through error-checking and validation routines. The EC application then returns a unique Event Identification (ID) code to the website owner. The Event ID code uniquely identifies the event.

When the website owner creates the web page associated with the applicable event, an icon supplied by the message system 130 is placed adjacent to the event listing in the web page. Associated with this icon are a hyperlink to a specific URL for the website at which the message application resides and the Event ID code, uniquely identifying the event.

After entering a URL for the host page 110 via, e.g., a web browser at a personal computer or wireless device, the user 100 receives the host page frame, including within it the page generated by the message system 130, which includes a hyperlink to the event information generated by the EC. When the user 100 clicks on the hyperlink, the Event ID is passed via the Internet 120 to the specified URL for the website at which the message application resides in the message system 130. This information is processed by the message system 130, e.g., by the application server 140, and the user 100 may be prompted for information, e.g., by the web server 150. Then, the user 100 inputs information regarding the desired messages, e.g., the time and/or date at which the user 100 desires to be reminded or information used by the messages system 130 for determining when the user should be notified. This information is processed, e.g., by the application server 140 and stored, e.g., in the database server 160. At the appropriate time, the mail server 170 provides the user 100 with message data regarding the event via the Internet 120.

The message data may include the timing of the event. The timing of the event may be expressed in a number of different ways. For example, the timing may be expressed as a date certain, e.g., September 12, 1999. Alternatively, the timing may be expressed relative to the date the user indicated a desire to receive information about the event. For example, for a website for wedding dresses, e.g., Weddingdresses.com, the user may be prompted to specify the wedding date, and the event message system 130, e.g., the application server 140, computes the message date that allows sufficient lead time to order and fit the dress.

To illustrate how the message system works, consider the following example. A user 100 selects a particular host web page 110, the page having embedded within it a hyperlink to the page containing the message application in the message system 130. The particular host web page promotes an on-line chat session hosted on Sep. 19, 1999. Next to the description of the chat session is a small icon with the caption “Remember”. When the user 100 clicks on that icon using the mouse, the web browser passes the Event ID as a parameter to the URL associated with the link via the Internet 120. This is how the event is identified by the message system 130. As a result, a message entry page is launched via the web server 150 and the Internet 120 in the existing browser window.

Next, the user 100 is prompted to enter information, e.g., the user's email address or wireless phone number. Additional information may be requested by the website owner. If the user 100 has not already registered, he or she may be prompted to register at this point. If registered, no additional information is required. After registration, the chat event is automatically placed on the user's message calendar for Sep. 19, 1999. The calendar may be stored, e.g., in the database server 160. When the date is reached, the message is sent to the user, e.g., via email or wireless message.

Assume that elsewhere on the website provided by the host 110, there is an offer for a $5.00 gift certificate in exchange for completing a 10-minute survey on-line. At the bottom of the page, the following message appears “Interested but short on time? Click the icon and we'll send a friendly message in a week”. To be reminded, the user 100 clicks on the icon “Remember it”, and the message entry page is launched as described above. Once the user 100 enters the required information, the event is placed on the user's message calendar for 7 days from that day. When the 7 days expires, a message is sent to the user, e.g., via email or wireless message.

As another example, consider again the web page for a Weddingdress.com website, at which a hyperlink to the web page containing the message application is included to remind a bride-to-be of an appointment for a fitting. At the Weddingdress.com web page, the user 100 clicks on the icon, causing the web browser to retrieve the message entry page from the web server 150. Assuming the user 100 is registered and has logged in, she is prompted by the web entry page to enter her wedding date. Assume that the developers of the website specified 10 weeks as the lead time required for fitting a dress when they created the website. Then, the message system 130 determines the date for placing the user's messages on the calendar as the later of 10 weeks prior to the wedding date or the next day, if the wedding is less than 10 weeks away, and the message is placed on the calendar at the appropriate date. When this date is reached, a message is sent to the user, e.g., via e-mail or wireless message.

Once a user 100 has registered with the message system 130 using the hyperlink at a particular website, he or she is not required to register again, even if the user accesses the message system via a hyperlink at another website. The user 100 only needs to remember the login information for a single message system, and this login information can be used to log into the system from any website containing the hyperlink to the message system.

Also, once a message is on the user's calendar, the message can be moved to another date by the user. Some special events may be specified as nonmovable, e.g., Christmas cannot be moved to December 15. When the date and/or time at which the message is set on the calendar is reached, a message is automatically sent to the user, e.g., via e-mail or wireless message.

Although the examples above are directed to host web pages at individual websites, the invention is applicable to any number of host pages at any number of websites. When a user registers at one website, this information may be shared by other websites, thus reducing the burden on the website owners. Also, the user event profile is portable among different websites.

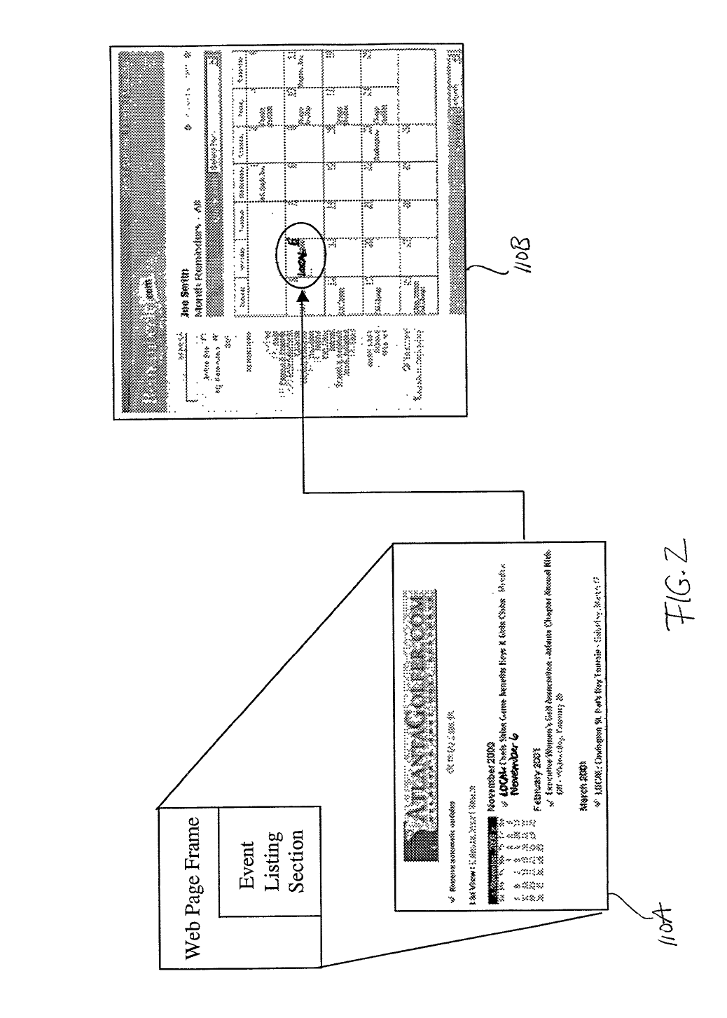

As an example of user event profile portability and data sharing between websites, consider the web pages shown in FIG. 2. Web page 110A is provided by a website for golfing events, AtlantaGolfer.com, and web page 110B is provided by a website for providing a calendar of event reminders, Rememberlt.com. Assume that a user registers with the message system via a link at the AtlantaGolfer.com web page 110A. The user may also provide other information to the AtlantaGolfer.com web page. The user indicates a desire to receive information about a golf event, which is added to the user's event profile in the message system. This information is editable at the AtlantaGolfer.com site. Assume that the user also visits the Rememberlt.com website. Information input by the user at the AtlantaGolfer.com website may be shared with the RememberIt.com website. Thus, the RememberIt.com website does not have to prompt the user for this information. In addition, the user event profile is portable between the websites. Thus, at the Rememberlt.com web page 110B, information regarding the golf event may be displayed along with information regarding other user events included in the user's event profile. The golf event information is also editable at this site. The AtlantaGolfer.com site can also display other information regarding other events included in the user event profile, and this information may be edited at the AtlantaGolfer.com web page. Thus, in effect, the message system acts as an infomediary.

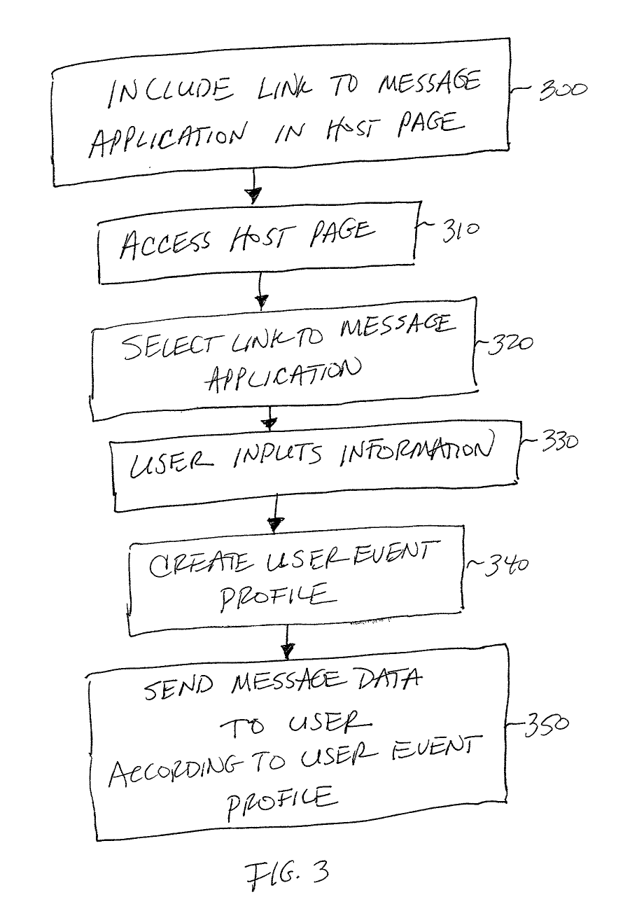

FIG. 3 illustrates a method for providing message data to users regarding events associated with websites. In the interest of simplicity, the following description relates to one event associated with one website accessed by one user. It will be appreciated, however, that the invention is applicable to any number of events associated with any number of websites accessible by any number of users. The method begins at step 300 at which a link to a message application is included in a host web page 110 for an event associated with the website for which message data is desired. This link represents the URL for the message system 130. At step 310, the host page is accessed, e.g., by a user 100. At step 320, the link to the message application associated with the event is selected. At step 330, the user 100 inputs information regarding the event, e.g., in response to a prompt from the message system. This information may include login information or, if the user is not registered, registration information. This information may also include data regarding the time at which the user 100 desires to receive information regarding the event. This information is included in a portable user event profile at step 340. At step 350, message data is automatically sent to the user 100 based on the information input by the user 100, e.g., the user event profile, at a time determined from the user input. The message may be sent in the form of an e-mail or wireless message. In this manner, the user 100 is automatically informed at the appropriate time of events that he or she is interested in.

To summarize, the method, system, and apparatus of the present invention provide message data to users for events associated with websites. The invention provides a very convenient, easy way for website owners to add event message functionality to their websites and for users to be provided with personalized message data regarding events in which they are interested. The website owner does not have to invest in the development and maintenance of his or her own message application, because the message application provided by the message system according to exemplary embodiments handles that functionality for the developer. Also, by consolidating the event message functionally of many websites in a single message system, user event profiles may be made portable between websites. In addition, user information may be shared between website owners, so that website owners do not have to prompt the user for the same information and users are not required to register on multiple sites, remember multiple user names and passwords, etc.

It should be understood that the foregoing description and accompanying drawings are by example only. A variety of modifications are envisioned that do not depart from the scope and spirit of the invention.

The above description is intended by way of example only and is not intended to limit the present invention in any way.

What is claimed is:

1. A method for providing message data regarding at least one event associated with at least one website to at least one user, the method comprising the steps of:
including in at least one web page at the website a link to a message application for each event associated with the web page for which message data is desired;
accessing the at least one web page;
selecting the link to the message application associated with the at least one event;
inputting user information; and
automatically sending messages to the user regarding the event, based on the input user information.

2. The method of claim 1, wherein the step of inputting user information is performed in response to a prompt to the user to input information.

3. The method of claim 1, wherein the step of inputting user information includes inputting user registration information if such information has not already been input by the user.

4. The method of claim 1, wherein a link to the same message application is included in each web page at each website for each event for which message data is desired.

5. The method of claim 1, wherein the message data is prepared based on the input user information and is sent to the user at a time determined according to the input user information.

6. The method of claim 1, wherein the message data includes information regarding the timing of the event.

7. The method of claim 1, wherein the message data is provided to the user via a personal computer.

8. The method of claim 1, wherein the message data is provided to the user via a wireless device.

9. The method of claim 1, further comprising sharing the information input by the user among different websites.

10. The method of claim 1, further comprising creating a user event profile including all events for which a user desires to receive message data.

11. The method of claim 10, wherein the user event profile is portable among different websites.

12. A system for providing message data regarding at least one event associated with at least one website to at least one user, the system comprising:
a host computer for hosting at least one web page at the website, wherein at least one event is associated with the website; and
a message system for providing a message application to the host computer and message data to a user, wherein the host computer includes in the web page a link to the message application provided by the message system for each event associated with the website for which messages are desired, a user accesses the web page, selects the link to the message application associated with the at least one event, and inputs user information, and the message system automatically sends message data to the user regarding the event, based on the input user information.

13. The system of claim 12, wherein the user inputs information in response to a prompt from the message system to input information.

14. The system of claim 12, wherein the user inputs user registration information if such information has not already been input by the user.

15. The system of claim 12, wherein a link to the same message application is included in each web page for each event for which message data is desired.

16. The system of claim 12, wherein the message system prepares message data based on the input user information and sends the message data to the user at a time determined according to the input user information.

17. The system of claim 12, wherein the message data includes information regarding the timing of the event.

18. The system of claim 12, wherein the message data is provided to the user via a personal computer.

19. The system of claim 12, wherein the message data is provided to the user via a wireless device.

20. The system of claim 12, wherein the information input by the user is shared among different websites.

21. The system of claim 12, wherein a user event profile is created including all events for which a user desires to receive message data.

22. The system of claim 21, wherein the user event profile is portable among different websites.

23. An apparatus for providing message data regarding at least one event associated with at least one website to at least one user, the apparatus comprising:
a web server for providing a link to at least one web page for a message application for each event associated with the website for which message data is desired, wherein a user accesses the at least one web page and selects the link to the message application associated with the at least one event;
a database server for receiving information input by the user regarding the event;
an application server for processing the information input by the user; and
a mail server for automatically sending message data to the user regarding the event, based on the input user information.

24. The apparatus of claim 23, wherein the web server prompts the user for information.

25. The apparatus of claim 23, wherein the user inputs user registration information if such information has not already been input by the user.

26. The apparatus of claim 23, wherein a link to the same message application is included in each website for each event for which message data is desired.

27. The apparatus of claim 23, wherein the database server prepares message data based on the input user information, and the mail server sends the message data to the user at a time determined according to the input user information.

28. The apparatus of claim 23, wherein the message data includes information regarding the timing of the event.

29. The apparatus of claim 23, wherein the message data is provided to the user via a personal computer.

30. The apparatus of claim 23, wherein the message data is provided to the user via a wireless device.

31. The apparatus of claim 23, wherein the information input by the user is shared among different websites.

32. The apparatus of claim 23, wherein a user event profile is created including all events for which a user desires to receive message data.

33. The apparatus of claim 32, wherein the user event profile is portable among different websites.
